(19) United States
(12) Patent Application Publication
(10) Pub. No.: US 2026/0205855 A1
(43) Pub. Date: Jul. 16, 2026

(54) SWITCHING BETWEEN BEAM MEASUREMENT AND BEAM PREDICTION REPORTING

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US); Hamed PEZESHKI, SAN DIEGO, CA (US)

(21) Appl. No.: 19/139,228

(22) PCT Filed: Feb. 2, 2023
(86) PCT No.: PCT/CN2023/074229

§ 371 Date: Jun. 13, 2025

(51) Int. Cl. H04W 24/10; H04B 7/06

(52) U.S. Cl. CPC H04W 24/10; H04B 7/0626; H04B 7/06952

(57) ABSTRACT

Methods, systems, and devices for wireless communication are described. A user equipment (UE) may receiving control signaling indicating a channel state information (CSI) report setting, which may indicate a set of reporting occasions, a quantity of measurement resources to report for a respective reporting occasion, and that a respective reporting occasion is associated with a channel measurement or a channel characteristic prediction. That is, the CSI report setting may indicate that the UE is to report channel measurements or predictions in respective reporting occasions. Based on the control signaling, the UE may generate a channel measurement or prediction for a given reporting occasion, and during the reporting occasion, the UE may transmit a measurement report indicating the generated channel measurement or prediction.

### CROSS REFERENCE

This application is a 371 National Stage of PCT Application No. PCT/CN 2023/074229, filed on Feb. 2, 2023, entitled “SWITCHING BETWEEN BEAM MEASUREMENT AND BEAM PREDICTION REPORTING”, and assigned to the assignee hereof. The disclosure of the prior Application is considered part of and is incorporated by reference into this Patent Application.

### FIELD OF TECHNOLOGY

The following relates to wireless communication, including switching between beam measurement and beam prediction reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may perform a beam management procedure, which may include beam measurements and beam predictions (e.g., predictions of future beam characteristics). In some examples, the UE may report measurement results, prediction results, or both in respective reporting occasions of a measurement report.

### SUMMARY

The described techniques relate to improved methods, systems, devices, and apparatuses that support switching between beam measurement and beam prediction reporting. For example, the described techniques provide for a channel state information (CSI) report setting that indicates some reporting occasions that are to be used for reporting channel measurements and some other reporting occasions that are to be used for reporting channel predictions. In some examples, a UE may receive control signaling indicating a CSI reporting setting, the CSI reporting setting indicating a set of multiple reporting occasions, a quantity of one or more measurement resources (e.g., channel measurement resources (CMRs)) to report for a respective reporting occasion, and that a respective reporting occasion is associated with channel measurement or channel characteristic prediction. That is, each reporting occasion may be used to report channel measurements or predictions. The UE may generate a channel measurement or a channel characteristic prediction for the one or more measurement resources and for a first reporting occasion based on the control signaling. For example, the UE may generate a channel measurement for the first reporting occasion, which may be a measurement occasion. The UE may transmit a measurement report during the first reporting occasion, the measurement report indicating the channel measurement or the channel characteristic prediction. In some examples, the network entity may request the UE to report a channel measurement instead of a channel characteristic prediction in a prediction occasion or a channel characteristic prediction instead of a channel measurement in a measurement occasion.

A method for wireless communication at a user equipment (UE) is described. The method may include receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction, generating, based on the control signaling and for a first reporting occasion of the set of multiple reporting occasions, a channel measurement for the quantity of the one or more measurement resources or a channel characteristic prediction for the quantity of the one or more measurement resources, and transmitting, during the first reporting occasion, a measurement report indicating one of the channel measurement for the quantity of the one or more measurement resources or the channel characteristic prediction for the quantity of the one or more measurement resources.

An apparatus for wireless communication at a UE is described. The apparatus may include a processor, memory coupled with the processor, and instructions stored in the memory. The instructions may be executable by the processor to cause the apparatus to receive control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction, generate, based on the control signaling and for a first reporting occasion of the set of multiple reporting occasions, a channel measurement for the quantity of the one or more measurement resources or a channel characteristic prediction for the quantity of the one or more measurement resources, and transmit, during the first reporting occasion, a measurement report indicating one of the channel measurement for the quantity of the one or more measurement resources or the channel characteristic prediction for the quantity of the one or more measurement resources.

Another apparatus for wireless communication at a UE is described. The apparatus may include means for receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction, means for generating, based on the control signaling and for a first reporting occasion of the set of multiple reporting occasions, a channel measurement for the quantity of the one or more measurement resources or a channel characteristic prediction for the quantity of the one or more measurement resources, and means for transmitting, during the first reporting occasion, a measurement report indicating one of the channel measurement for the quantity of the one or more measurement resources or the channel characteristic prediction for the quantity of the one or more measurement resources.

A non-transitory computer-readable medium storing code for wireless communication at a UE is described. The code may include instructions executable by a processor to receive control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction, generate, based on the control signaling and for a first reporting occasion of the set of multiple reporting occasions, a channel measurement for the quantity of the one or more measurement resources or a channel characteristic prediction for the quantity of the one or more measurement resources, and transmit, during the first reporting occasion, a measurement report indicating one of the channel measurement for the quantity of the one or more measurement resources or the channel characteristic prediction for the quantity of the one or more measurement resources.

In some examples of the method, apparatuses, and non-transitory computer-readable medium described herein, one bit of the CSI reporting setting indicates that the measurement report includes one of the channel measurement or the channel characteristic prediction for the respective reporting occasion.

Some examples of the method, apparatuses, and non-transitory computer-readable medium described herein may further include operations, features, means, or instructions for switching the respective reporting occasion from being associated with one of the channel measurement or the channel characteristic prediction to being associated with the other one of the channel measurement or the channel characteristic prediction based on a confidence level associated with the channel characteristic prediction failing to satisfy a confidence threshold.

Some examples of the method, apparatuses, and non-transitory computer-readable medium described herein may further include operations, features, means, or instructions for receiving the control signaling requesting the UE to switch one or more reporting occasions from being associated with one of the channel measurement or the channel characteristic prediction to being associated with the other one of the channel measurement or the channel characteristic prediction.

In some examples of the method, apparatuses, and non-transitory computer-readable medium described herein, receiving the control signaling may include operations, features, means, or instructions for receiving a medium access control (MAC) control element (MAC-CE) or downlink control information (DCI) requesting the UE to switch a next reporting occasion of the set of multiple reporting occasions from being associated with one of the channel measurement or the channel characteristic prediction to being associated with the other one of the channel measurement or the channel characteristic prediction.

In some examples of the method, apparatuses, and non-transitory computer-readable medium described herein, receiving the control signaling may include operations, features, means, or instructions for receiving a MAC-CE or DCI indicating a change in a quantity of reporting occasions of the set of multiple reporting occasions associated with the channel measurement and a change in a quantity of reporting occasions of the set of multiple reporting occasions associated with the channel characteristic prediction.

Some examples of the method, apparatuses, and non-transitory computer-readable medium described herein may further include operations, features, means, or instructions for transmitting a feedback message indicating reception of the control signaling requesting to switch the one or more reporting occasions, where the feedback message includes an acknowledgment message or a one-bit indication.

In some examples of the method, apparatuses, and non-transitory computer-readable medium described herein, receiving the control signaling may include operations, features, means, or instructions for receiving an uplink grant triggering the UE to transmit an aperiodic CSI report based on the CSI reporting setting.

In some examples of the method, apparatuses, and non-transitory computer-readable medium described herein, a priority of the aperiodic CSI report may be higher than a priority of the measurement report, and where the measurement report may be a periodic measurement report or a semi-persistent measurement report.

In some examples of the method, apparatuses, and non-transitory computer-readable medium described herein, the uplink grant indicates a change in a quantity of reporting occasions of the set of multiple reporting occasions associated with the channel measurement and a change in a quantity of reporting occasions of the set of multiple reporting occasions associated with the channel characteristic prediction, where the measurement report may be associated with the first reporting occasion.

In some examples of the method, apparatuses, and non-transitory computer-readable medium described herein, the quantity of the one or more measurement resources to report may be based on a measurement of the one or more measurement resources associated with a reference resource of the first reporting occasion.

In some examples of the method, apparatuses, and non-transitory computer-readable medium described herein, the quantity of the one or more measurement resources to report may be based on a channel characteristic prediction for the one or more measurement resources associated with a reference resource of the first reporting occasion.

Some examples of the method, apparatuses, and non-transitory computer-readable medium described herein may further include operations, features, means, or instructions for transmitting control signaling indicating the quantity of one or more measurement resources.

Some examples of the method, apparatuses, and non-transitory computer-readable medium described herein may further include operations, features, means, or instructions for transmitting capability signaling indicating a capability of the UE to report the quantity of one or more measurement resources.

A method for wireless communication at network entity is described. The method may include transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction and receiving, during a first reporting occasion of the set of multiple reporting occasions, a measurement report indicating one of a channel measurement for the quantity of the one or more measurement resources or a channel characteristic prediction for the quantity of the one or more measurement resources.

An apparatus for wireless communication at network entity is described. The apparatus may include a processor, memory coupled with the processor, and instructions stored in the memory. The instructions may be executable by the processor to cause the apparatus to transmit, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction and receive, during a first reporting occasion of the set of multiple reporting occasions, a measurement report indicating one of a channel measurement for the quantity of the one or more measurement resources or a channel characteristic prediction for the quantity of the one or more measurement resources.

Another apparatus for wireless communication at network entity is described. The apparatus may include means for transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction and means for receiving, during a first reporting occasion of the set of multiple reporting occasions, a measurement report indicating one of a channel measurement for the quantity of the one or more measurement resources or a channel characteristic prediction for the quantity of the one or more measurement resources.

A non-transitory computer-readable medium storing code for wireless communication at network entity is described. The code may include instructions executable by a processor to transmit, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction and receive, during a first reporting occasion of the set of multiple reporting occasions, a measurement report indicating one of a channel measurement for the quantity of the one or more measurement resources or a channel characteristic prediction for the quantity of the one or more measurement resources.

In some examples of the method, apparatuses, and non-transitory computer-readable medium described herein, one bit of the CSI reporting setting indicates that the measurement report includes one of the channel measurement or the channel characteristic prediction for the respective reporting occasion.

Some examples of the method, apparatuses, and non-transitory computer-readable medium described herein may further include operations, features, means, or instructions for transmitting the control signaling requesting the UE to switch one or more reporting occasions from being associated with one of the channel measurement or the channel characteristic prediction to being associated with the other one of the channel measurement or the channel characteristic prediction.

In some examples of the method, apparatuses, and non-transitory computer-readable medium described herein, transmitting the control signaling may include operations, features, means, or instructions for transmitting a MAC-CE or DCI requesting the UE to switch a next reporting occasion of the set of multiple reporting occasions from being associated with one of the channel measurement or the channel characteristic prediction to being associated with the other one of the channel measurement or the channel characteristic prediction.

In some examples of the method, apparatuses, and non-transitory computer-readable medium described herein, transmitting the control signaling may include operations, features, means, or instructions for transmitting a MAC-CE or DCI indicating a change in a quantity of reporting occasions of the set of multiple reporting occasions associated with the channel measurement and a change in a quantity of reporting occasions of the set of multiple reporting occasions associated with the channel characteristic prediction.

Some examples of the method, apparatuses, and non-transitory computer-readable medium described herein may further include operations, features, means, or instructions for receiving a feedback message indicating reception of the control signaling requesting to switch the one or more reporting occasions, where the feedback message includes an acknowledgment message or a one-bit indication.

In some examples of the method, apparatuses, and non-transitory computer-readable medium described herein, transmitting the control signaling may include operations, features, means, or instructions for transmitting an uplink grant triggering the UE to transmit an aperiodic CSI report based on the CSI reporting setting.

In some examples of the method, apparatuses, and non-transitory computer-readable medium described herein, a priority of the aperiodic CSI report may be higher than a priority of the measurement report, and where the measurement report may be a periodic measurement report or a semi-persistent measurement report.

In some examples of the method, apparatuses, and non-transitory computer-readable medium described herein, the uplink grant indicates a change in a quantity of reporting occasions of the set of multiple reporting occasions associated with the channel measurement and a change in a quantity of reporting occasions of the set of multiple reporting occasions associated with the channel characteristic prediction, where the measurement report may be associated with the first reporting occasion.

In some examples of the method, apparatuses, and non-transitory computer-readable medium described herein, the quantity of the one or more measurement resources to report may be based on a measurement of the one or more measurement resources associated with a reference resource of the first reporting occasion.

In some examples of the method, apparatuses, and non-transitory computer-readable medium described herein, the quantity of the one or more measurement resources to report may be based on a channel characteristic prediction for the one or more measurement resources associated with a reference resource of the first reporting occasion.

Some examples of the method, apparatuses, and non-transitory computer-readable medium described herein may further include operations, features, means, or instructions for receiving control signaling indicating the quantity of one or more measurement resources.

Some examples of the method, apparatuses, and non-transitory computer-readable medium described herein may further include operations, features, means, or instructions for receiving capability signaling indicating a capability of the UE to report the quantity of one or more measurement resources.

### BRIEF DESCRIPTION OF THE DRAWINGS

FIG. 1 illustrates an example of a wireless communications system that supports switching between beam measurement and beam prediction reporting in accordance with one or more aspects of the present disclosure.

FIG. 2 illustrates an example of a wireless communications system that supports switching between beam measurement and beam prediction reporting in accordance with one or more aspects of the present disclosure.

FIG. 3 illustrates an example of a CSI report configuration that supports switching between beam measurement and beam prediction reporting in accordance with one or more aspects of the present disclosure.

FIG. 4 illustrates an example of a process flow that supports switching between beam measurement and beam prediction reporting in accordance with one or more aspects of the present disclosure.

FIGS. 5 and 6 illustrate diagrams of devices that support switching between beam measurement and beam prediction reporting in accordance with one or more aspects of the present disclosure.

FIG. 7 illustrates a diagram of a communications manager that supports switching between beam measurement and beam prediction reporting in accordance with one or more aspects of the present disclosure.

FIG. 8 illustrates a diagram of a system including a device that supports switching between beam measurement and beam prediction reporting in accordance with one or more aspects of the present disclosure.

FIGS. 9 and 10 illustrate diagrams of devices that support switching between beam measurement and beam prediction reporting in accordance with one or more aspects of the present disclosure.

FIG. 11 illustrates a diagram of a communications manager that supports switching between beam measurement and beam prediction reporting in accordance with one or more aspects of the present disclosure.

FIG. 12 illustrates a diagram of a system including a device that supports switching between beam measurement and beam prediction reporting in accordance with one or more aspects of the present disclosure.

FIGS. 13 through 17 illustrate flowcharts showing methods that support switching between beam measurement and beam prediction reporting in accordance with one or more aspects of the present disclosure.

### DETAILED DESCRIPTION

Wireless devices, such as UEs, may use beam management procedures including beam measurements and beam prediction to reduce overhead and latency and improve beam selection accuracy. In some examples, a UE may report multiple time instances in a single report for time-domain beam predictions. That is, the UE may include multiple measurements at different times in a same report. However, this may cause a payload size of the report to grow with the quantity of time instances at which the UE performed a measurement, which may result in scheduling restrictions based on a large payload size. Additionally, or alternatively, it may be unnecessary for the UE to deliver predicted results regarding multiple future time domain occasions in a report. For example, the future time-domain occasions may occur much later than a time at which a UE performed a beam measurement or prediction, and as such, delivering the report quickly may be an inefficient use of resources.

Techniques, systems, and devices described herein support dynamic switching between beam measurement and beam prediction reporting across respective occasions, which may reduce overhead and latency of beam reporting. For example, the described techniques may support CSI report configuration enhancement for a measurement and prediction reporting timeline, an indication of whether a reporting occasion is associated with a measurement or a prediction, and dynamic indications from a network entity (with confirmation from a UE) regarding overwriting whether a reporting occasion is associated with a measurement or a prediction.

A UE may receive control signaling indicating a CSI reporting setting, the CSI reporting setting indicating a set of multiple reporting occasions, a quantity of one or more measurement resources (e.g., CMRs) to report for a respective reporting occasion, and that a respective reporting occasion is associated with channel measurement or channel characteristic prediction. That is, each reporting occasion may be a measurement occasion used for reporting channel measurements or a prediction occasion used for reporting channel characteristic predictions. The UE may generate a channel measurement or a channel characteristic prediction for the one or more measurement resources and for a first reporting occasion based on the control signaling. For example, the UE may generate a channel measurement for the first reporting occasion, which may be a measurement occasion. The UE may transmit a measurement report during the first reporting occasion, the measurement report indicating the channel measurement or the channel characteristic prediction. In some examples, the network entity may request the UE to report a channel measurement instead of a channel characteristic prediction in a prediction occasion or a channel characteristic prediction instead of a channel measurement in a measurement occasion.

Aspects of the disclosure are initially described in the context of wireless communications systems. Aspects of the disclosure are then described in the context of CSI report configurations and process flows. Aspects of the disclosure are further illustrated by and described with reference to apparatus diagrams, system diagrams, and flowcharts that relate to switching between beam measurement and beam prediction reporting.

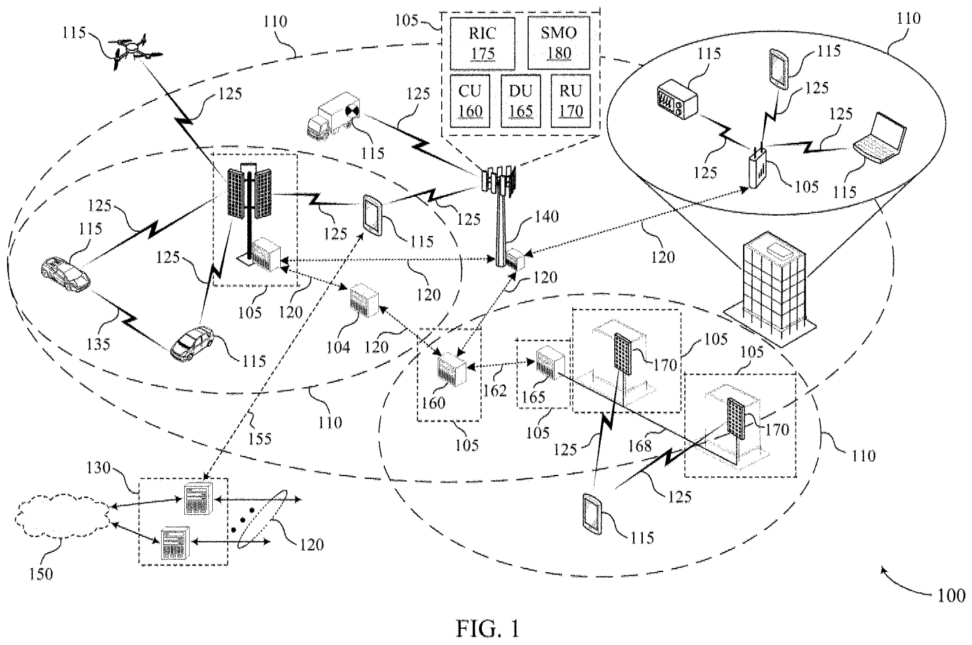

FIG. 1 illustrates an example of a wireless communications system 100 that supports switching between beam measurement and beam prediction reporting in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1(L 1 ) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support switching between beam measurement and beam prediction reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may perform beam management procedures (e.g., in an RRC connected mode), which may include beam failure detection and recovery, beam predictions, and other procedures based on beam measurements. For example, the UE 115 may perform beam predictions in a time domain, a spatial domain or both for overhead and latency reduction and beam selection accuracy improvement. Such beam predictions may be based on an artificial intelligence (AI) or machine learning model. For example, the UE 115 may perform spatial-domain downlink beam predictions for a first set of beams based on measurement results of a second set of beams, or the UE 115 may perform temporal downlink beam predictions for the first set of beams based on historic (e.g., previous) measurement results of the second set of beams.

In some examples, if the UE 115 predicts future beam characteristics using an AI or machine learning model, the UE 115 may determine one or more beams of N future time instances based on the output of the model and how to report them (e.g., in a single reporting occasion). In some cases, reporting multiple time instances in a single L1 report for time-domain beam predictions may have limitations. For example, a payload size of a single L1 report may grow linearly with a quantity of time instances. As such, the report may require a large physical uplink control channel (PUCCH) payload size, which may result in scheduling restrictions. Alternatively, it may be unnecessary to deliver predicted results regarding multiple future time domain occasions using the L1 report. Such multiple future time domain occasions may be tens to hundreds of milliseconds later than the time when the UE 115 made a beam prediction, such that delivering the results to a network entity 105 quickly may be unnecessary.

Alternatively, a UE 115 may use a defined timeline for periodic or semi-persistent L1 reporting, where some reporting occasions may be used to report prediction results while some other reporting occasions may be used to report measurement results. This may reduce a payload size of each L1 report, which may reduce scheduling restrictions. For example, the reporting timeline may specify a pattern of two measurement reporting occasions followed by three prediction reporting occasions, and so on, with a 20 ms L 1-report periodicity and based on a CSI reference resource definition. As such, the UE 115 may report measurement or prediction results across various respective reporting occasions, which may reduce the payload size of the report.

In such cases, a beam measurement report may be dynamically-triggered or event-triggered by a UE 115 or dynamically controlled or requested by the network entity 105 (e.g., based on outer-loop performance or a UE-observed confidence level with respect to a prediction). In some examples, the timeline, periodicity of the report, or both may be dynamically overwritten, for example for performance monitoring, dynamic machine learning activation and deactivation, or both. For example, prediction cycle reporting may occur after a CMR occasion, such that the UE 115 may have the flexibility to indicate to the network entity 105 whether the results are based on measurement or prediction, via an additional (but very limited) payload. In some other examples, the network entity 105 may use dynamic signaling to request that the UE 115 reports measurement results instead of prediction results during a prediction cycle, with the UE 115 using additional payload in the report as confirmation of the dynamic signaling from the network entity 105.

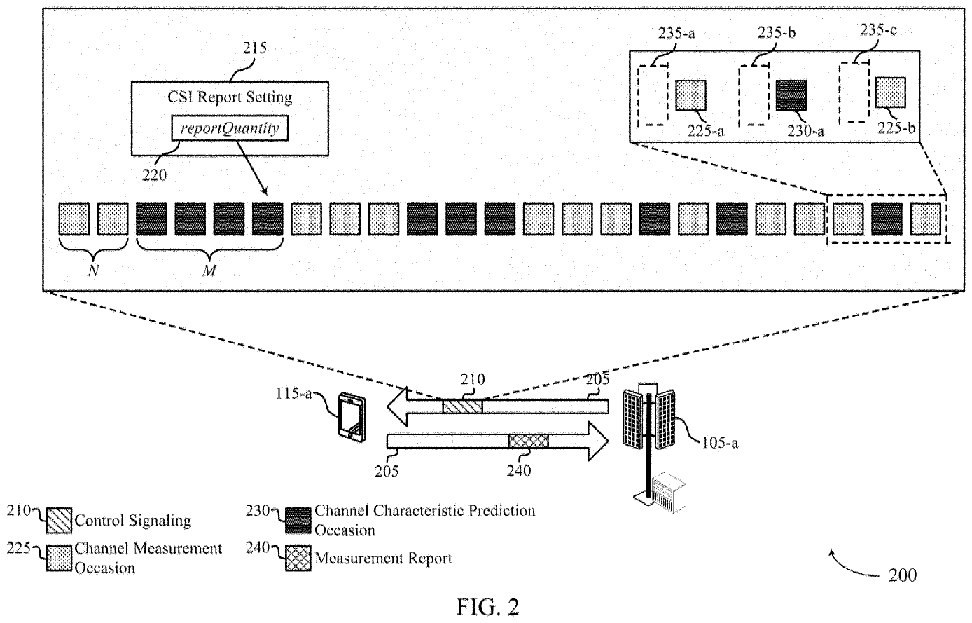

FIG. 2 illustrates an example of a wireless communications system 200 that supports switching between beam measurement and beam prediction reporting in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices described herein. The UE 115-a and the network entity 105-a may support time-domain channel measurement and prediction reporting, which may reduce overhead and latency and improve beam selection accuracy.

The wireless communications system 200 may support communications between the UE 115-a and the network entity 105-a. For example, the UE 115-a and the network entity 105-a may perform uplink and downlink communications via respective communications links 205, which may be examples of communications links 125 described herein with reference to FIG. 1. In some examples, the UE 115-a and the network entity 105-a may support a channel reporting configuration based on signaling transmitted via the communications links 205, the channel reporting configuration including interleaved time domain measurement and prediction reports (e.g., L1 reports).

In some examples, the UE 115-a may receive control signaling 210 that includes a CSI report setting 215 and a reportQuantity information element 220. The CSI report setting 215 may indicate a set of multiple reporting occasions for reporting channel measurements or channel characteristic predictions, and the reportQuantity information element 220 may indicate a quantity of one or more measurement resources to report for a respective reporting occasion of the set of multiple reporting occasions.

In addition, the control signaling 210 may indicate that a respective reporting occasion is associated with a channel measurement or a channel characteristic prediction.

Reporting occasions associated with (e.g., used for) channel measurements may be referred to as channel measurement occasions 225 and reporting occasions associated with (e.g., used for) channel characteristic predictions may be referred to as channel characteristic prediction occasions 230. In some examples, the CSI report setting 215 may indicate that the UE 115-a is to transmit interleaved time-domain measurement and prediction reports (e.g., L1 reports).

In some examples, the control signaling 210 may indicate that the CSI report setting 215 is periodic or semi-persistent, and the reportQuantity information element 220 may indicate at least one of an L1-reference signal received power (RSRP), an L1-signal interference-to-noise ratio (SINR), a rank indicator (RI), a PMI, or a channel quality indicator (CQI) regarding CMRs associated with the CSI report setting 215. In some cases, the reportQuantity information element 220 associated with a particular reporting occasion may be based on an actual measurement of CMRs associated with a CSI reference resource of the reporting occasion or based on channel characteristic predictions of the CMRs associated with the CSI reference resource of the reporting occasion without actual measurements on the CMRs associated with the CSI reference resource of the reporting occasion. In this way, the quantity of the one or more measurement resources to report may be based on a measurement (e.g., a channel measurement) or a channel characteristic prediction of the one or more measurement resources associated with a reference resource of a reporting occasion. In some examples, the CMRs may be cell-specific CSI-RSs or synchronization signal blocks (SSBs) such that the network entity 105-a may transmit the CMRs even if the UE 115-a refrains from measuring cell-specific CSI-RSs or SSB, or both, in given occasions.

In some examples, the CSI report setting 215 may indicate a pattern of interleaved channel measurement occasions 225 and channel characteristic prediction occasions 230, and the UE 115-a may be expected to report measurement and prediction results after the CSI reporting setting 215 is configured or activated. For example, based on the CSI report setting 215 and the reportQuantity information element 220, the UE 115-a may be expected to report measurement results for a first N consecutive reporting occasions (e.g., channel measurement occasions 225), then report prediction results for the next M consecutive reporting occasions (e.g., channel characteristic prediction occasions 230), then report measurement results for a next N consecutive reporting occasions, and then report prediction results of the next M consecutive reporting occasions, and so on for some quantity of measurement cycles and prediction cycles. In some examples, the values of N and M may be indicated in the CSI report setting 215, indicated by a MAC-CE activating the CSI report (if semi-persistent), or pre-recommended by the UE 115-a (e.g., via a MAC-CE or capability reporting). For example, the UE 115-a may transmit control signaling indicating a quantity (e.g., N and M) of the measurement resources, or the UE 115-a may transmit capability signaling indicating a capability of the UE !15-a to report the quantity of the measurement resources.

Based on the control signaling 210, the UE 115-a may generate a channel measurement or a channel characteristic prediction for the quantity of measurement resources indicated in the reportQuantity information element 220. The UE 115-a may generate the channel measurement or the channel characteristic prediction for a first reporting occasion of the set of multiple reporting occasions indicated in the CSI report setting 215. For example, if the first reporting occasion is a channel measurement occasion 225, then the UE 115-a may generate the channel measurement.

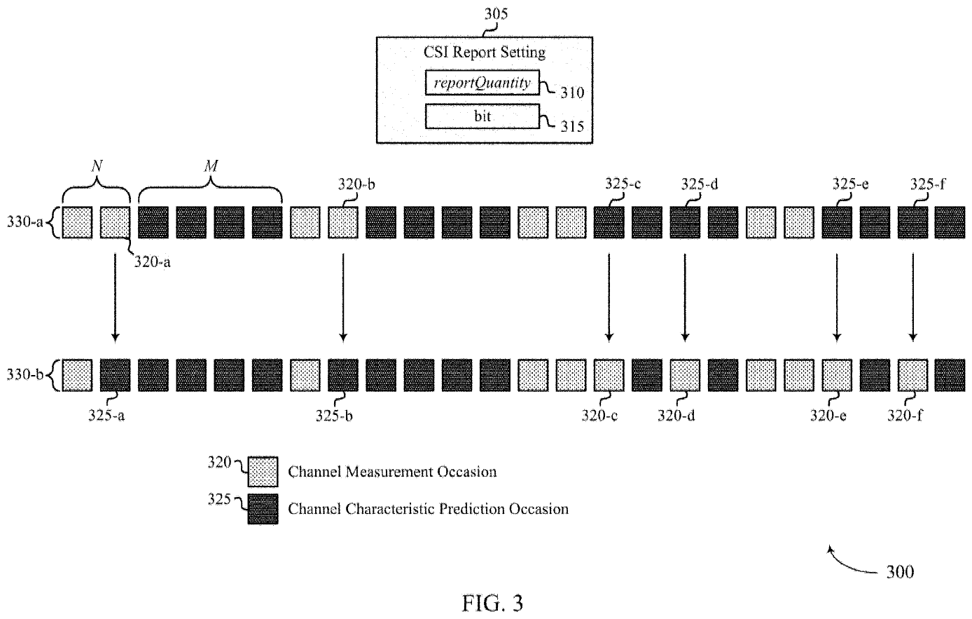

In some cases, the CSI reference resource or a CMR monitoring occasion 235 associated with a reporting occasion for reporting the predicted measurement resources predicted in the reportQuantity information element 220 may precede a reporting occasion (e.g., a slot carrying a corresponding CSI report). For example, a CMR monitoring occasion 235-a may precede a channel measurement occasion 225-a, a CMR monitoring occasion 235-b may precede a channel characteristic prediction occasion 230-a, a CMR monitoring occasion 235-c may proceed a channel measurement occasion 225-b, and so on. As such, although the UE 115-a may have already predicted L1-RSRPs of CMRs 20 ms later, the UE 115-a may wait until the time 20 ms later (even later than the CMRs have actually been transmitted regarding the predicted time domain occasion), then to eventually report the prediction results in a report. That is, as described herein with reference to FIG. 3, the CMR monitoring occasions 235 may enable the UE 115-a to switch the use of a given channel measurement occasion 225 or channel characteristic prediction occasion 230. In addition, such timeline arrangements may allow flexibility on a UE-triggered switch or a network-controlled switch to reporting actual measurements instead of reporting prediction results.

In some examples, the UE 115-a may transmit a measurement report 240 indicating the channel measurement or the channel characteristic prediction for the quantity of the one or more measurement resources. The UE 115-a may transmit the measurement report 240 during the first reporting occasion. For example, the UE 115-a may transmit a measurement report 240 indicating the channel measurement during the channel measurement occasion 225-a. In this way, the UE 115-a may report channel measurements and predictions in L1 reports (such as the measurement report 240) while maintaining a relatively small payload size of each report such that the UE 115-a lacks scheduling restrictions.

FIG. 3 illustrates an example of a CSI report configuration 300 that supports switching between beam measurement and beam prediction reporting in accordance with one or more aspects of the present disclosure. In some examples, the CSI report configuration 300 may be implemented by the wireless communications systems 100 and 200. For example, a network entity 105 may enable a UE 115 with the CSI report configuration 300, which may include interleaved time domain measurement and prediction reports (e.g., L1 reports).

As described herein with reference to FIG. 2, a UE 115 control signaling that includes a CSI report setting 305 and a reportQuantity information element 310. The CSI report setting 305 may indicate a set of multiple reporting occasions for reporting channel measurements or channel characteristic predictions, and the reportQuantity information element 310 may indicate a quantity of one or more measurement resources to report for a respective reporting occasion of the set of multiple reporting occasions.

In addition, the control signaling may indicate that a respective reporting occasion is associated with a channel measurement or a channel characteristic prediction. Reporting occasions associated with (e.g., used for) channel measurements may be referred to as channel measurement occasions 320 and reporting occasions associated with (e.g., used for) channel characteristic predictions may be referred to as channel characteristic prediction occasions 325. In some examples, the CSI report setting 305 may indicate that the UE 115 is to transmit interleaved time-domain measurement and prediction reports (e.g., L1 reports).

In some examples, after receiving the CSI report setting 305, the UE 115 may be expected to report measurement results for a first N consecutive reporting occasions (e.g., channel measurement occasions 320), then report prediction results for the next M consecutive reporting occasions (e.g., channel characteristic prediction occasions 325), then report measurement results for a next N consecutive reporting occasions, and then report prediction results of the next M consecutive reporting occasions, and so on for some quantity of measurement cycles and prediction cycles. For example, a CSI report 330-a may include N=2 channel measurement occasions 320 followed by M=4 channel characteristic prediction occasions 325, and so on. In some examples, the values of N and M may be indicated in the CSI report setting 305 or indicated by a MAC-CE activating a CSI report 330 (if semi-persistent). As such, the network entity 105 may manage the configuration of CSI reports 330.

The UE 115 may trigger a switch from utilizing the channel measurement occasions 320 for reporting measurement results to prediction results or the channel characteristic prediction occasions 325 for reporting prediction results to measurement results. In some cases, the reportQuantity information element 310 may include a bit 315 (e.g., an additional bit) that may indicate whether a payload is based on measurement or prediction. That is, one bit 315 of the CSI report setting 305 may indicate that a CSI report 330 (a measurement report) includes a channel measurement or a channel characteristic prediction for a respective reporting occasion. The one-bit indication may overwrite the values of N and M initially indicated (configured) by the network entity 105.

As the bit 315 may change the configuration of the reporting occasions for a CSI report 330, the UE 115 may utilize the bit 315 to switch reporting occasions from being used for measurement reporting to prediction reporting or for prediction reporting to measurement reporting. In some examples, the UE 115 may switch the reporting occasions based on a triggering event which may include predefined triggers, an indication (configuration) from a network entity 105, or a recommendation by the UE 115. For example, a triggering event may include identifying that a confidence level associated with a channel characteristic prediction is below a predefined, network-configured, or UE-reported threshold value. That is, the UE 115 may switch a respective reporting occasion (e.g., a channel measurement occasion 320 or a channel characteristic prediction occasion 325) from being associated with one of the channel measurement or the channel characteristic prediction to being associated with the other one of the channel measurement or the channel characteristic prediction based on a confidence level associated with the channel characteristic prediction failing to satisfy a confidence threshold. In some other example, the triggering event may include identifying that a predicted L1-RSRP of a strongest CMR is X dB greater than a predicted L1-RSRP of a CMR that is a TypeD-quasi co-location (QCL) source of a transmission configuration indicator (TCI) state for a most recently scheduled physical downlink shared channel (PDSCH) or physical downlink control channel (PDCCH).

In some examples, the UE 115 may use the bit 315 to determine a quantity of channel measurement occasions 320 and channel characteristic prediction occasions 325 with or without the reportQuantity information element 310 being included in the CSI report setting 305. For example, if the network entity 105 fails to indicate the quantities N and M, the UE 115 may determine the quantities and use them in a CSI report 330 without having to overwrite the network-configured values.

Alternatively, the network entity 105 may control the prediction-to-measurement or measurement-to-prediction switch as described herein. For example, the network entity 105 may use DCI or a MAC-CE to request the UE 115 to switch one or more reporting occasions associated with prediction or measurement results, where the UE 115 may receive the DCI or the MAC-CE before the corresponding one or more reporting occasions. That is, the UE 115 may receive control signaling (e.g., the DCI or the MAC-CE) requesting the UE 115 to switch one or more reporting occasions from being associated with one of the channel measurement or the channel characteristic prediction to being associated with the other one of the channel measurement or the channel characteristic prediction.

In some examples, the network entity 105 may transmit a MAC-CE requesting the UE 115 to switch the one or more reporting occasions. The MAC-CE may include a CSI report setting identifier associated with the CSI report setting 305 (and a periodic or semi-persistent CSI report 330). In addition, the UE 115 may use the MAC-CE to switch one or more reporting occasions from or to a channel measurement occasion 320 or a channel characteristic prediction occasion 325. For example, based on the MAC-CE, the UE 115 may switch a most recent next reporting occasion from being used for reporting channel measurements or predictions to reporting channel predictions or measurements. Additionally, or alternatively, the MAC-CE may request the UE 115 to switch the ratio of N/M (e.g., a quantity of channel measurement occasions 320 to channel characteristic prediction occasions 325) to an alternative value different from the N and M values configured in the CSI report setting 305 (e.g., the periodic or semi-persistent CSI report setting).

In some cases, the UE 115 may transmit an ACK feedback message confirming reception of the MAC-CE without using the bit 315 to indicate a use of a reporting occasion (e.g., omit a bit indicating whether a payload of a CSI report is based on measurement or prediction). Alternatively, the UE 115 may use the bit 315 as feedback regarding whether the UE 115 successfully received the MAC-CE switching command. That is, the UE 115 may transmit a feedback message indicating reception of the control signaling (e.g., the MAC-CE or DCI) requesting to switch the one or more reporting occasions, where the feedback message may include an ACK message or a one-bit indication (e.g., the bit 315).

In some cases, the network entity 105 may transmit DCI requesting the UE 115 to switch the one or more reporting occasions (e.g., from measurement to prediction, or from prediction to measurement). The DCI may be based on using dedicated DCI fields, DCI formats, radio network temporary identifiers (RNTIs), or a combination thereof. In some examples, the DCI may trigger the UE 115 to switch the most recent next reporting occasion from being associated with predictions to being associated with measurements or from being associated with measurements to being associated with predictions. Additionally, or alternatively, the DCI may indicate a ratio of NIM to an alternative value different from that indicated in the CSI report setting 305 (e.g., the periodic or semi-persistent CSI reporting setting).

In this way, the UE 115 may receive a MAC-CE or DCI requesting the UE 115 to switch a next reporting occasion from being associated with one of the channel measurement or the channel characteristic prediction to being associated with the other one of the channel measurement or the channel characteristic prediction. Additionally, or alternatively, the UE 115 may receive a MAC-CE or DCI indicating a change in a quantity of reporting occasions associated with the channel measurement (e.g., N) and a change in a quantity of reporting occasions associated with the channel characteristic prediction (e.g., M).

In some examples, the DCI may be an uplink grant DCI with one or more CSI request fields that trigger transmission of one or more aperiodic CSI reports. The UE 115 may receive an uplink grant triggering the UE 115 to transmit an aperiodic CSI report based on the CSI report setting 305. For example, the DCI may include an information element CSI-AssociatedReportConfigInfo corresponding to one of the aperiodic CSI reports being triggered. This may be linked with the periodic or semi-persistent CSI report setting 305, for example, by including the CSI report setting identifier in CSI-AssociatedReportConfigInfo. In addition, a reportQuantity information element and associated CMRs for the aperiodic CSI report may be identical to the reportQuantity information element 310 and associated CMRs indicated in the CSI report setting 305. In some examples, there may be an additional flag in CSI-AssociatedReportConfigInfo indicating this usage of the aperiodic CSI report. In some examples, a priority of the aperiodic CSI report may be higher than a priority of a CSI report 330.

In some examples, the UE 115 may switch from reporting prediction results to reporting measurement results or from reporting measurement results to reporting prediction results in a reporting occasion adjacent to a slot in which the UE 115 receives the DCI. If a periodic or semi-persistent CSI report 330 is carried via PUCCH, the UE 115 may report the aperiodic CAI report via the same PUCCH resource (e.g., the DCI may trigger the aperiodic CSI report on a PUCCH instead of a physical uplink shared channel (PUSCH)).

In some cases, the DCI may be an uplink grant DCI with one or more CSI request fields triggering one or more aperiodic CSI reports, where the CSI-AssociatedReportConfigInfo may include an alternative ratio of N/M such that the UE 115 may update the ratio starting from a next most recent reporting occasion (e.g., as if that is the first active reporting occasion). That is, the uplink grant may indicate a change in a quantity of reporting occasions associated with the channel measurement (e.g., N) and a change in a quantity of reporting occasions associated with the channel characteristic prediction (e.g., M), where the measurement report is associated with a first reporting occasion. In some cases, the UE 115 may use the bit 315 to confirm reception of the DCI switch command.

Based on an event trigger initiated by the UE 115 or control signaling (e.g., a MAC-CE or DCI) from the network entity 105, the UE 115 may switch whether a reporting occasion is used for reporting measurements or predictions, which may differ from the CSI report setting 305. For example, the reportQuantity information element 310 in the CSI report setting 305 may indicate N=2 channel measurement occasions 320 followed by M=5 channel characteristic prediction occasions 325 for the CSI report 340-a. Based on the event trigger or the control signaling from the network entity 105, the UE 115 may switch the channel measurement occasions 320 to be used for reporting channel characteristic predictions (effectively switching the channel measurement occasions 320 to be channel characteristic prediction occasions 325) and the channel characteristic prediction occasions 325 to be used for reporting channel measurements (effectively switching the channel characteristic prediction occasions 325 to be channel measurement occasions 320).

The UE 115 may switch channel measurement occasions 320 and channel characteristic prediction occasions 325 from the CSI report 340-a in a CSI report 340-a. For example, the UE 115 may switch a channel measurement occasion 320-a in the CSI report 340-a to a channel characteristic prediction occasion 325-a in the CSI report 340-b. Additionally, or alternatively, the UE 115 may switch a channel measurement occasion 320-b to a channel characteristic prediction occasion 325-b, a channel characteristic prediction occasion 325-c to a channel measurement occasion 320-c, a channel characteristic prediction occasion 325-d to a channel measurement occasion 320-d, a channel characteristic prediction occasion 325-e to a channel measurement occasion 320-e, and a channel characteristic prediction occasion 325-f to a channel measurement occasion 320-f. In this way, the CSI report 340-b may include channel measurement reports in channel characteristic prediction occasions 325 and channel characteristic reports in channel measurement occasions 320.

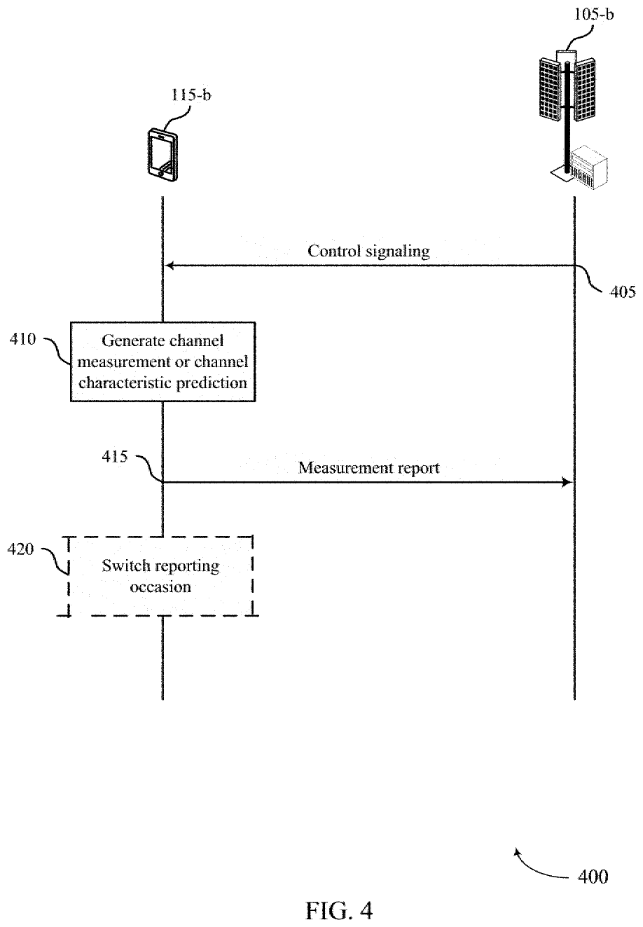

FIG. 4 illustrates an example of a process flow 400 that supports switching between beam measurement and beam prediction reporting in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between a UE 115-b and a network entity 105-b, which may be examples of corresponding devices described herein. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive control signaling identifying a CSI reporting setting indicating a set of multiple of reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. In some examples, the CSI reporting setting may include a reportQuantity information element that indicates the quantity. In some examples, the CSI reporting setting may indicate that the reporting occasions associated with the channel measurements or the channel characteristic prediction are interleaved in a CSI (e.g., measurement) report.

At 410, the UE 115-b may generate, based on the control signaling and for a first reporting occasion of the set of multiple of reporting occasions, a channel measurement for the quantity of the one or more measurement resources or a channel characteristic prediction for the quantity of the one or more measurement resources. For example, if the first reporting occasion is associated with channel measurement, the UE 115-b may generate a channel measurement for reporting in the first reporting occasion.

At 415, the UE 115-b may transmit, during the first reporting occasion, a measurement report indicating one of the channel measurement for the quantity of the one or more measurement resources or the channel characteristic prediction for the quantity of the one or more measurement resources. In some examples, the measurement report may be a periodic or semi-persistent CSI report.

At 420, the UE 115-b may switch the respective reporting occasion from being associated with one of the channel measurement or the channel characteristic prediction to being associated with the other one of the channel measurement or the channel characteristic prediction based on control signaling (e.g., a MAC-CE, DCI) from the network entity 105-b, a recommendation from the UE 115-b, or a predefined event trigger. For example, the UE 115-b may switch a reporting occasion based on a confidence level associated with the channel characteristic prediction failing to satisfy a confidence threshold. In this way, the UE 115-b may use a reporting occasion for channel measurements for reporting a channel characteristic prediction or a reporting occasion for channel characteristic predictions for reporting a channel measurement.

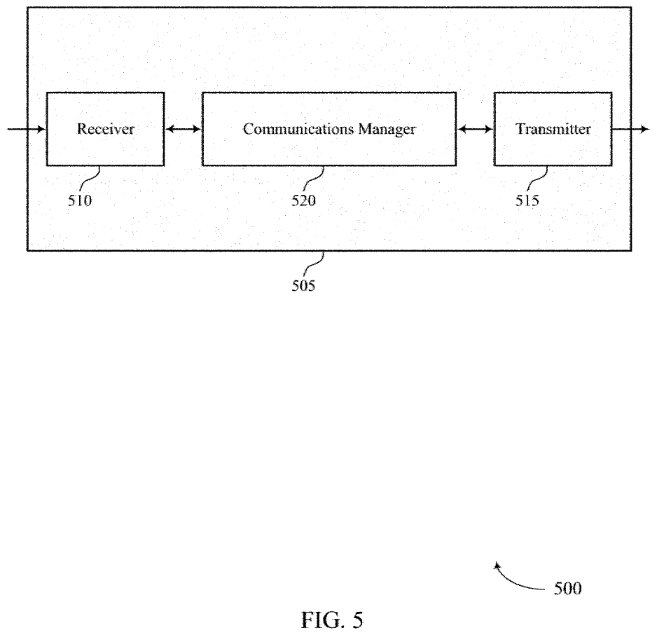

FIG. 5 illustrates a diagram 500 of a device 505 that supports switching between beam measurement and beam prediction reporting in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to switching between beam measurement and beam prediction reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to switching between beam measurement and beam prediction reporting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of switching between beam measurement and beam prediction reporting as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The communications manager 520 may be configured as or otherwise support a means for generating, based on the control signaling and for a first reporting occasion of the set of multiple reporting occasions, a channel measurement for the quantity of the one or more measurement resources or a channel characteristic prediction for the quantity of the one or more measurement resources. The communications manager 520 may be configured as or otherwise support a means for transmitting, during the first reporting occasion, a measurement report indicating one of the channel measurement for the quantity of the one or more measurement resources or the channel characteristic prediction for the quantity of the one or more measurement resources.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for switching between reporting channel measurements and channel characteristic predictions in respective reporting occasions, which may reduce latency, reduce overhead, and improve beam selection accuracy.

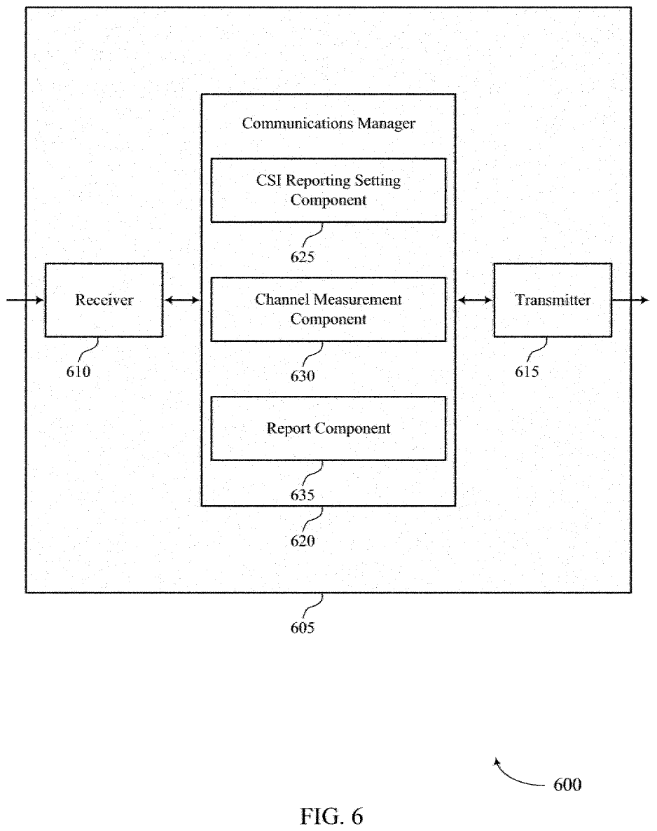

FIG. 6 illustrates a diagram 600 of a device 605 that supports switching between beam measurement and beam prediction reporting in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to switching between beam measurement and beam prediction reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to switching between beam measurement and beam prediction reporting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of switching between beam measurement and beam prediction reporting as described herein. For example, the communications manager 620 may include a CSI reporting setting component 625, a channel measurement component 630, a report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The CSI reporting setting component 625 may be configured as or otherwise support a means for receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The channel measurement component 630 may be configured as or otherwise support a means for generating, based on the control signaling and for a first reporting occasion of the set of multiple reporting occasions, a channel measurement for the quantity of the one or more measurement resources or a channel characteristic prediction for the quantity of the one or more measurement resources. The report component 635 may be configured as or otherwise support a means for transmitting, during the first reporting occasion, a measurement report indicating one of the channel measurement for the quantity of the one or more measurement resources or the channel characteristic prediction for the quantity of the one or more measurement resources.

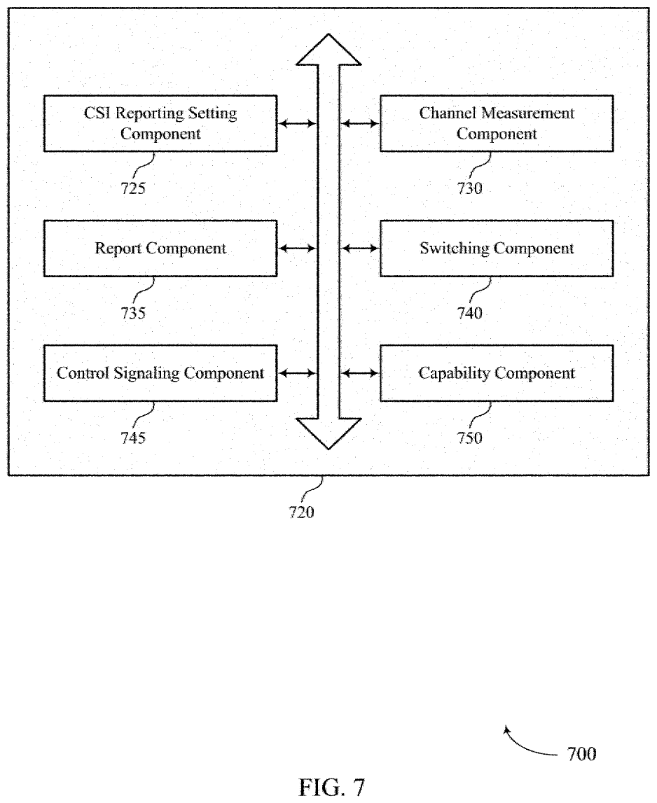

FIG. 7 illustrates a diagram 700 of a communications manager 720 that supports switching between beam measurement and beam prediction reporting in accordance with one or more aspects of the present disclosure. The communications manager 720 may be an example of aspects of a communications manager 520, a communications manager 620, or both, as described herein. The communications manager 720, or various components thereof, may be an example of means for performing various aspects of switching between beam measurement and beam prediction reporting as described herein. For example, the communications manager 720 may include a CSI reporting setting component 725, a channel measurement component 730, a report component 735, a switching component 740, a control signaling component 745, a capability component 750, or any combination thereof. Each of these components may communicate, directly or indirectly, with one another (e.g., via one or more buses).

The communications manager 720 may support wireless communication at a UE in accordance with examples as disclosed herein. The CSI reporting setting component 725 may be configured as or otherwise support a means for receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The channel measurement component 730 may be configured as or otherwise support a means for generating, based on the control signaling and for a first reporting occasion of the set of multiple reporting occasions, a channel measurement for the quantity of the one or more measurement resources or a channel characteristic prediction for the quantity of the one or more measurement resources. The report component 735 may be configured as or otherwise support a means for transmitting, during the first reporting occasion, a measurement report indicating one of the channel measurement for the quantity of the one or more measurement resources or the channel characteristic prediction for the quantity of the one or more measurement resources.

In some examples, one bit of the CSI reporting setting indicates that the measurement report includes one of the channel measurement or the channel characteristic prediction for the respective reporting occasion.

In some examples, the switching component 740 may be configured as or otherwise support a means for switching the respective reporting occasion from being associated with one of the channel measurement or the channel characteristic prediction to being associated with the other one of the channel measurement or the channel characteristic prediction based on a confidence level associated with the channel characteristic prediction failing to satisfy a confidence threshold.

In some examples, the control signaling component 745 may be configured as or otherwise support a means for receiving the control signaling requesting the UE to switch one or more reporting occasions from being associated with one of the channel measurement or the channel characteristic prediction to being associated with the other one of the channel measurement or the channel characteristic prediction.

In some examples, to support receiving the control signaling, the control signaling component 745 may be configured as or otherwise support a means for receiving a MAC-CE or DCI requesting the UE to switch a next reporting occasion of the set of multiple reporting occasions from being associated with one of the channel measurement or the channel characteristic prediction to being associated with the other one of the channel measurement or the channel characteristic prediction.

In some examples, to support receiving the control signaling, the control signaling component 745 may be configured as or otherwise support a means for receiving a MAC-CE or DCI indicating a change in a quantity of reporting occasions of the set of multiple reporting occasions associated with the channel measurement and a change in a quantity of reporting occasions of the set of multiple reporting occasions associated with the channel characteristic prediction.

In some examples, the switching component 740 may be configured as or otherwise support a means for transmitting a feedback message indicating reception of the control signaling requesting to switch the one or more reporting occasions, where the feedback message includes an ACK message or a one-bit indication.

In some examples, to support receiving the control signaling, the CSI reporting setting component 725 may be configured as or otherwise support a means for receiving an uplink grant triggering the UE to transmit an aperiodic CSI report based on the CSI reporting setting.

In some examples, a priority of the aperiodic CSI report is higher than a priority of the measurement report, and where the measurement report is a periodic measurement report or a semi-persistent measurement report.

In some examples, the uplink grant indicates a change in a quantity of reporting occasions of the set of multiple reporting occasions associated with the channel measurement and a change in a quantity of reporting occasions of the set of multiple reporting occasions associated with the channel characteristic prediction, where the measurement report is associated with the first reporting occasion.

In some examples, the quantity of the one or more measurement resources to report is based on a measurement of the one or more measurement resources associated with a reference resource of the first reporting occasion.

In some examples, the quantity of the one or more measurement resources to report is based on a channel characteristic prediction for the one or more measurement resources associated with a reference resource of the first reporting occasion.

In some examples, the CSI reporting setting component 725 may be configured as or otherwise support a means for transmitting control signaling indicating the quantity of one or more measurement resources.

In some examples, the capability component 750 may be configured as or otherwise support a means for transmitting capability signaling indicating a capability of the UE to report the quantity of one or more measurement resources.

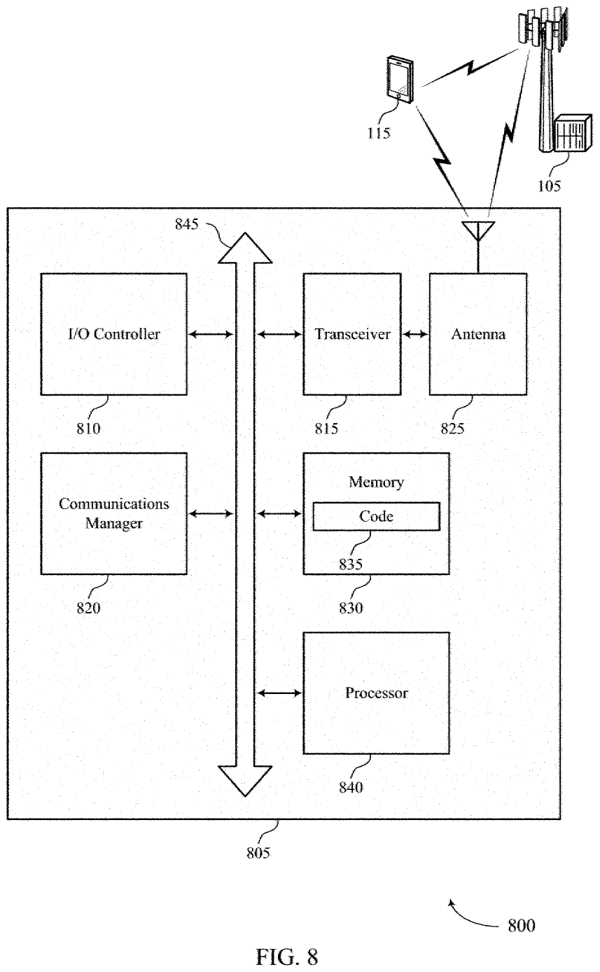

FIG. 8 illustrates a diagram of a system 800 including a device 805 that supports switching between beam measurement and beam prediction reporting in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting switching between beam measurement and beam prediction reporting). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The communications manager 820 may be configured as or otherwise support a means for generating, based on the control signaling and for a first reporting occasion of the set of multiple reporting occasions, a channel measurement for the quantity of the one or more measurement resources or a channel characteristic prediction for the quantity of the one or more measurement resources. The communications manager 820 may be configured as or otherwise support a means for transmitting, during the first reporting occasion, a measurement report indicating one of the channel measurement for the quantity of the one or more measurement resources or the channel characteristic prediction for the quantity of the one or more measurement resources.

By including or configuring the communications manager 820 in accordance with examples as described herein, the device 805 may support techniques for switching between reporting channel measurements and channel characteristic predictions in respective reporting occasions, which may reduce latency, reduce overhead, and improve beam selection accuracy.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of switching between beam measurement and beam prediction reporting as described herein, or the processor 840 and the memory 830 may be otherwise configured to perform or support such operations.

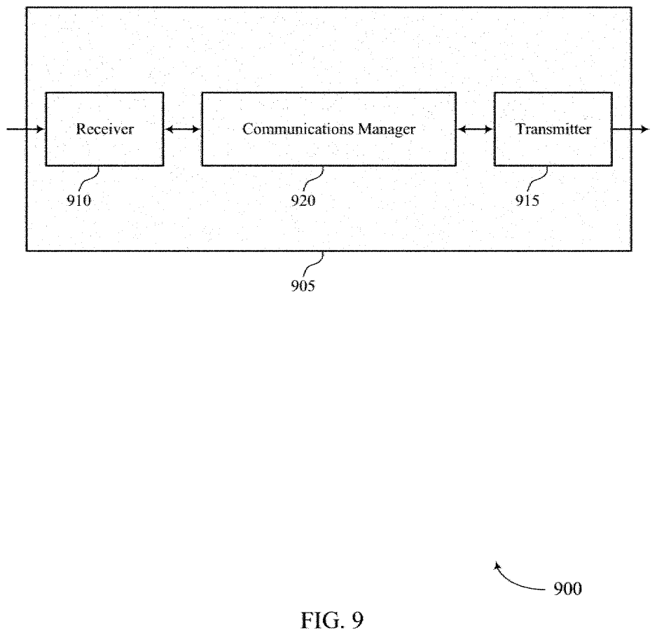

FIG. 9 illustrates a diagram 900 of a device 905 that supports switching between beam measurement and beam prediction reporting in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of switching between beam measurement and beam prediction reporting as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at network entity in accordance with examples as disclosed herein. For example, the communications manager 920 may be configured as or otherwise support a means for transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The communications manager 920 may be configured as or otherwise support a means for receiving, during a first reporting occasion of the set of multiple reporting occasions, a measurement report indicating one of a channel measurement for the quantity of the one or more measurement resources or a channel characteristic prediction for the quantity of the one or more measurement resources.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for switching between reporting channel measurements and channel characteristic predictions in respective reporting occasions, which may reduce latency, reduce overhead, and improve beam selection accuracy.

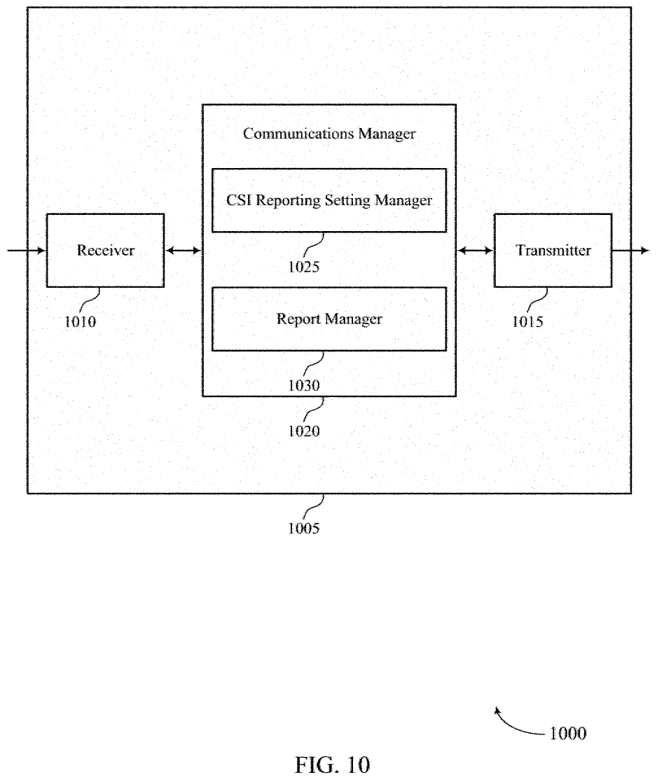

FIG. 10 illustrates a diagram 1000 of a device 1005 that supports switching between beam measurement and beam prediction reporting in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of switching between beam measurement and beam prediction reporting as described herein. For example, the communications manager 1020 may include a CSI reporting setting manager 1025 a report manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at network entity in accordance with examples as disclosed herein. The CSI reporting setting manager 1025 may be configured as or otherwise support a means for transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The report manager 1030 may be configured as or otherwise support a means for receiving, during a first reporting occasion of the set of multiple reporting occasions, a measurement report indicating one of a channel measurement for the quantity of the one or more measurement resources or a channel characteristic prediction for the quantity of the one or more measurement resources.

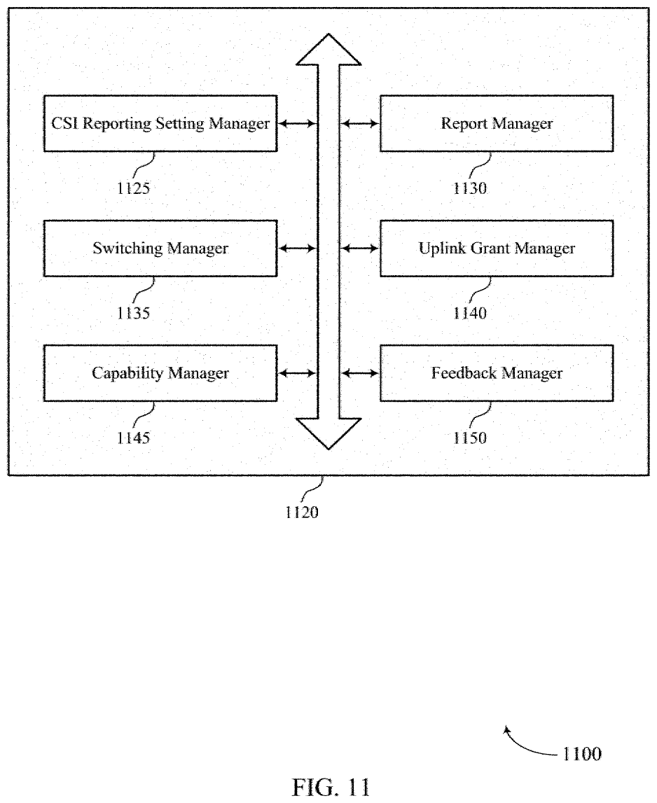

FIG. 11 illustrates a diagram 1100 of a communications manager 1120 that supports switching between beam measurement and beam prediction reporting in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of switching between beam measurement and beam prediction reporting as described herein. For example, the communications manager 1120 may include a CSI reporting setting manager 1125, a report manager 1130, a switching manager 1135, an uplink grant manager 1140, a capability manager 1145, a feedback manager 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at network entity in accordance with examples as disclosed herein. The CSI reporting setting manager 1125 may be configured as or otherwise support a means for transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The report manager 1130 may be configured as or otherwise support a means for receiving, during a first reporting occasion of the set of multiple reporting occasions, a measurement report indicating one of a channel measurement for the quantity of the one or more measurement resources or a channel characteristic prediction for the quantity of the one or more measurement resources.

In some examples, one bit of the CSI reporting setting indicates that the measurement report includes one of the channel measurement or the channel characteristic prediction for the respective reporting occasion.

In some examples, the switching manager 1135 may be configured as or otherwise support a means for transmitting the control signaling requesting the UE to switch one or more reporting occasions from being associated with one of the channel measurement or the channel characteristic prediction to being associated with the other one of the channel measurement or the channel characteristic prediction.

In some examples, to support transmitting the control signaling, the switching manager 1135 may be configured as or otherwise support a means for transmitting a MAC-CE or DCI requesting the UE to switch a next reporting occasion of the set of multiple reporting occasions from being associated with one of the channel measurement or the channel characteristic prediction to being associated with the other one of the channel measurement or the channel characteristic prediction.

In some examples, to support transmitting the control signaling, the switching manager 1135 may be configured as or otherwise support a means for transmitting a MAC-CE or DCI indicating a change in a quantity of reporting occasions of the set of multiple reporting occasions associated with the channel measurement and a change in a quantity of reporting occasions of the set of multiple reporting occasions associated with the channel characteristic prediction.

In some examples, the feedback manager 1150 may be configured as or otherwise support a means for receiving a feedback message indicating reception of the control signaling requesting to switch the one or more reporting occasions, where the feedback message includes an ACK message or a one-bit indication.

In some examples, to support transmitting the control signaling, the uplink grant manager 1140 may be configured as or otherwise support a means for transmitting an uplink grant triggering the UE to transmit an aperiodic CSI report based on the CSI reporting setting.

In some examples, a priority of the aperiodic CSI report is higher than a priority of the measurement report, and where the measurement report is a periodic measurement report or a semi-persistent measurement report.

In some examples, the uplink grant indicates a change in a quantity of reporting occasions of the set of multiple reporting occasions associated with the channel measurement and a change in a quantity of reporting occasions of the set of multiple reporting occasions associated with the channel characteristic prediction, where the measurement report is associated with the first reporting occasion.

In some examples, the quantity of the one or more measurement resources to report is based on a measurement of the one or more measurement resources associated with a reference resource of the first reporting occasion.

In some examples, the quantity of the one or more measurement resources to report is based on a channel characteristic prediction for the one or more measurement resources associated with a reference resource of the first reporting occasion.

In some examples, the CSI reporting setting manager 1125 may be configured as or otherwise support a means for receiving control signaling indicating the quantity of one or more measurement resources.

In some examples, the capability manager 1145 may be configured as or otherwise support a means for receiving capability signaling indicating a capability of the UE to report the quantity of one or more measurement resources.

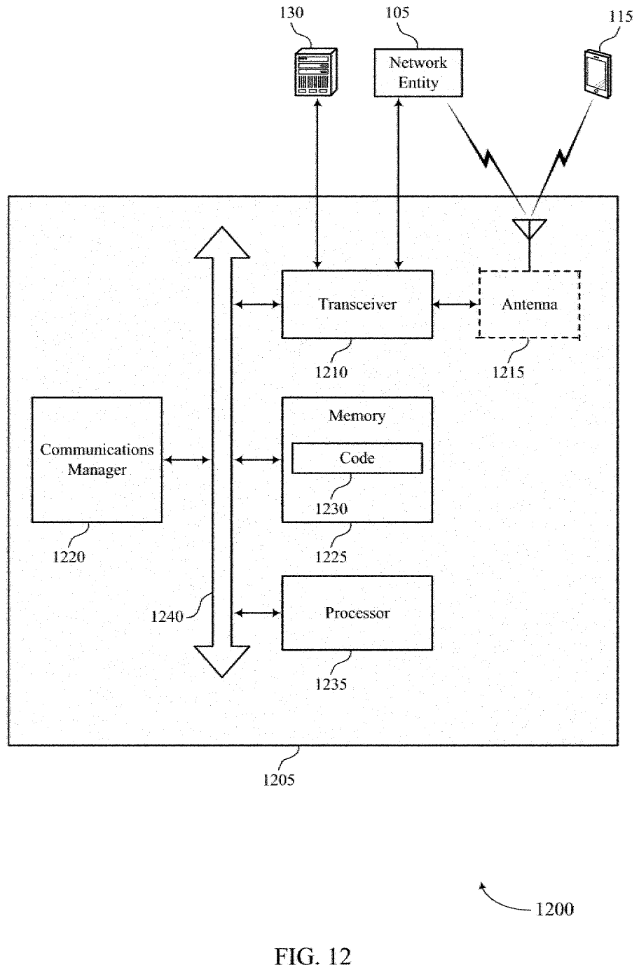

FIG. 12 illustrates a diagram of a system 1200 including a device 1205 that supports switching between beam measurement and beam prediction reporting in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting switching between beam measurement and beam prediction reporting). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at network entity in accordance with examples as disclosed herein. For example, the communications manager 1220 may be configured as or otherwise support a means for transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The communications manager 1220 may be configured as or otherwise support a means for receiving, during a first reporting occasion of the set of multiple reporting occasions, a measurement report indicating one of a channel measurement for the quantity of the one or more measurement resources or a channel characteristic prediction for the quantity of the one or more measurement resources.

By including or configuring the communications manager 1220 in accordance with examples as described herein, the device 1205 may support techniques for switching between reporting channel measurements and channel characteristic predictions in respective reporting occasions, which may reduce latency, reduce overhead, and improve beam selection accuracy.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of switching between beam measurement and beam prediction reporting as described herein, or the processor 1235 and the memory 1225 may be otherwise configured to perform or support such operations.

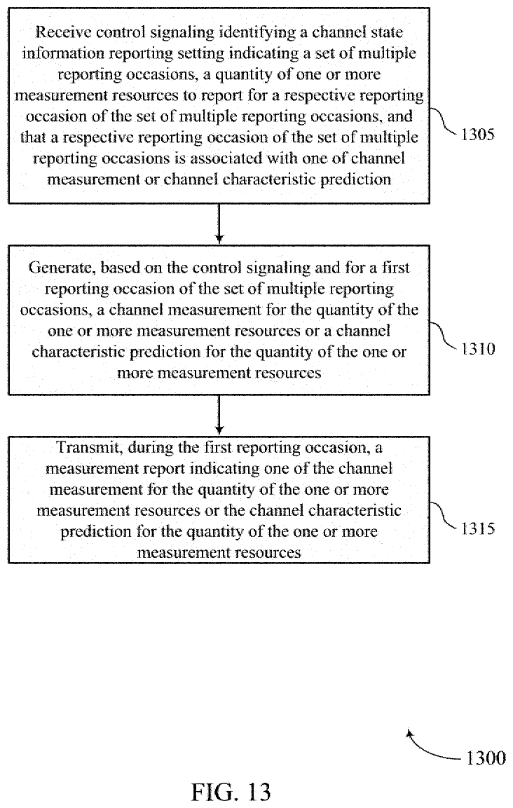

FIG. 13 illustrates a flowchart showing a method 1300 that supports switching between beam measurement and beam prediction reporting in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The operations of 1305 may be performed in accordance with examples as disclosed herein. In some examples, aspects of the operations of 1305 may be performed by a CSI reporting setting component 725 as described with reference to FIG. 7.

At 1310, the method may include generating, based on the control signaling and for a first reporting occasion of the set of multiple reporting occasions, a channel measurement for the quantity of the one or more measurement resources or a channel characteristic prediction for the quantity of the one or more measurement resources. The operations of 1310 may be performed in accordance with examples as disclosed herein. In some examples, aspects of the operations of 1310 may be performed by a channel measurement component 730 as described with reference to FIG. 7.

At 1315, the method may include transmitting, during the first reporting occasion, a measurement report indicating one of the channel measurement for the quantity of the one or more measurement resources or the channel characteristic prediction for the quantity of the one or more measurement resources. The operations of 1315 may be performed in accordance with examples as disclosed herein. In some examples, aspects of the operations of 1315 may be performed by a report component 735 as described with reference to FIG. 7.

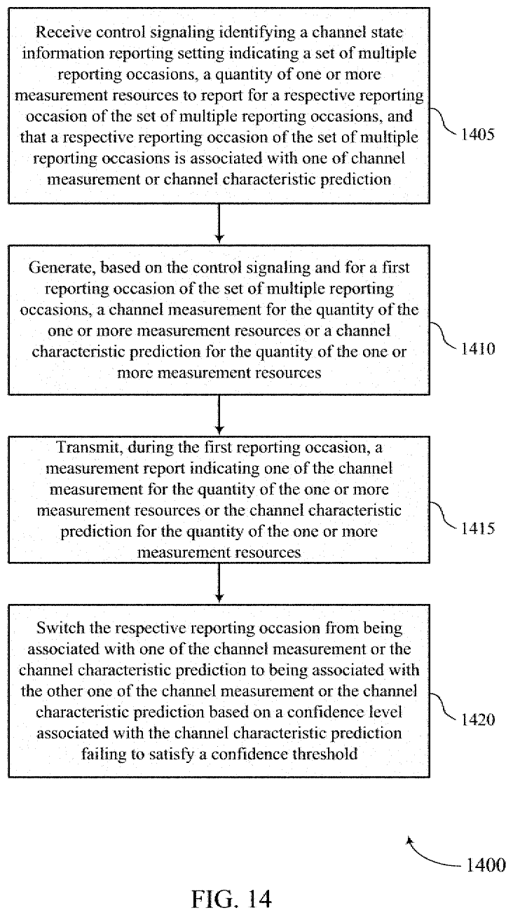

FIG. 14 illustrates a flowchart showing a method 1400 that supports switching between beam measurement and beam prediction reporting in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The operations of 1405 may be performed in accordance with examples as disclosed herein. In some examples, aspects of the operations of 1405 may be performed by a CSI reporting setting component 725 as described with reference to FIG. 7.

At 1410, the method may include generating, based on the control signaling and for a first reporting occasion of the set of multiple reporting occasions, a channel measurement for the quantity of the one or more measurement resources or a channel characteristic prediction for the quantity of the one or more measurement resources. The operations of 1410 may be performed in accordance with examples as disclosed herein. In some examples, aspects of the operations of 1410 may be performed by a channel measurement component 730 as described with reference to FIG. 7.

At 1415, the method may include transmitting, during the first reporting occasion, a measurement report indicating one of the channel measurement for the quantity of the one or more measurement resources or the channel characteristic prediction for the quantity of the one or more measurement resources. The operations of 1415 may be performed in accordance with examples as disclosed herein. In some examples, aspects of the operations of 1415 may be performed by a report component 735 as described with reference to FIG. 7.

At 1420, the method may include switching the respective reporting occasion from being associated with one of the channel measurement or the channel characteristic prediction to being associated with the other one of the channel measurement or the channel characteristic prediction based on a confidence level associated with the channel characteristic prediction failing to satisfy a confidence threshold. The operations of 1420 may be performed in accordance with examples as disclosed herein. In some examples, aspects of the operations of 1420 may be performed by a switching component 740 as described with reference to FIG. 7.

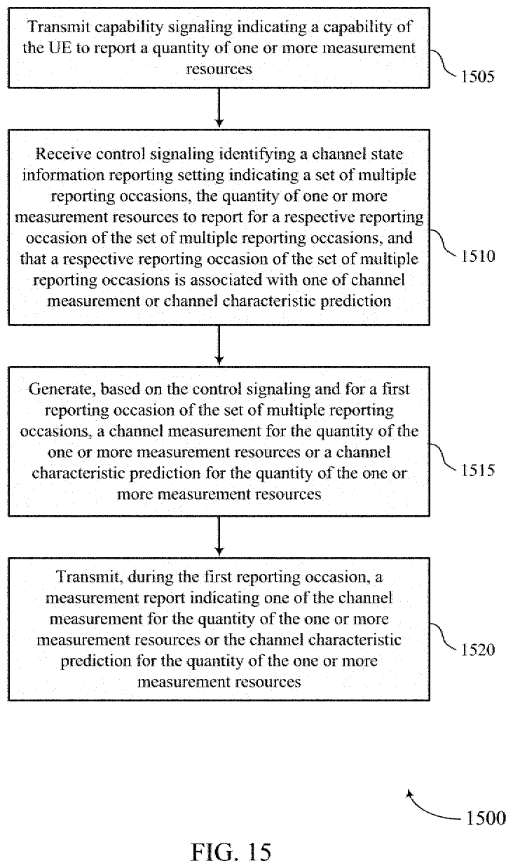

FIG. 15 illustrates a flowchart showing a method 1500 that supports switching between beam measurement and beam prediction reporting in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting capability signaling indicating a capability of the UE to report a quantity of one or more measurement resources. The operations of 1505 may be performed in accordance with examples as disclosed herein. In some examples, aspects of the operations of 1505 may be performed by a capability component 750 as described with reference to FIG. 7.

At 1510, the method may include receiving control signaling identifying a CSI reporting setting indicating a set of multiple reporting occasions, the quantity of one or more measurement resources to report for a respective reporting occasion of the set of multiple reporting occasions, and that a respective reporting occasion of the set of multiple reporting occasions is associated with one of channel measurement or channel characteristic prediction. The operations of 1510 may be performed in accordance with examples as disclosed herein. In some examples, aspects of the operations of 1510 may be performed by a CSI reporting setting component 725 as described with reference to FIG. 7.

At 1515, the method may include generating, based on the control signaling and for a first reporting occasion of the set of multiple reporting occasions, a channel measurement for the quantity of the one or more measurement resources or a channel characteristic prediction for the quantity of the one or more measurement resources. The operations of 1515 may be performed in accordance with examples as disclosed herein. In some examples, aspects of the operations of 1515 may be performed by a channel measurement component 730 as described with reference to FIG. 7.

At 1520, the method may include transmitting, during the first reporting occasion, a measurement report indicating one of the channel measurement for the quantity of the one or more measurement resources or the channel characteristic prediction for the quantity of the one or more measurement resources. The operations of 1520 may be performed in accordance with examples as disclosed herein. In some examples, aspects of the operations of 1520 may be performed by a report component 735 as described with reference to FIG. 7.

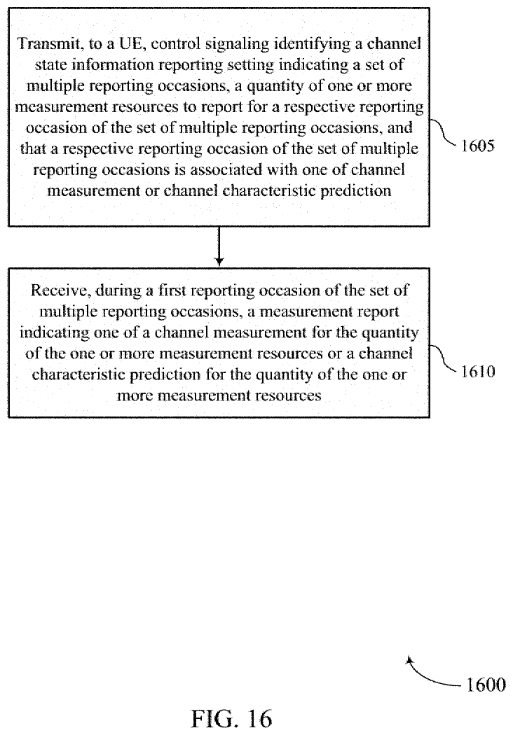

FIG. 16 illustrates a flowchart showing a method 1600 that supports switching between beam measurement and beam prediction reporting in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The operations of 1605 may be performed in accordance with examples as disclosed herein. In some examples, aspects of the operations of 1605 may be performed by a CSI reporting setting manager 1125 as described with reference to FIG. 11.

At 1610, the method may include receiving, during a first reporting occasion of the set of multiple reporting occasions, a measurement report indicating one of a channel measurement for the quantity of the one or more measurement resources or a channel characteristic prediction for the quantity of the one or more measurement resources. The operations of 1610 may be performed in accordance with examples as disclosed herein. In some examples, aspects of the operations of 1610 may be performed by a report manager 1130 as described with reference to FIG. 11.

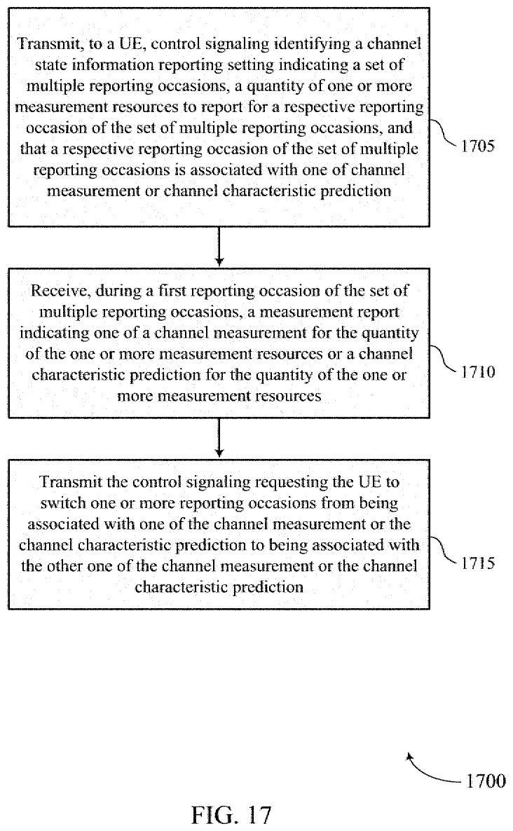

FIG. 17 illustrates a flowchart showing a method 1700 that supports switching between beam measurement and beam prediction reporting in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, control signaling identifying a CSI reporting setting indicating a set of multiple reporting occasions, a quantity of one or more measurement resources to report for a respective reporting occasion of the set of multiple reporting occasions, and that a respective reporting occasion of the set of multiple reporting occasions is associated with one of channel measurement or channel characteristic prediction. The operations of 1705 may be performed in accordance with examples as disclosed herein. In some examples, aspects of the operations of 1705 may be performed by a CSI reporting setting manager 1125 as described with reference to FIG. 11.

At 1710, the method may include receiving, during a first reporting occasion of the set of multiple reporting occasions, a measurement report indicating one of a channel measurement for the quantity of the one or more measurement resources or a channel characteristic prediction for the quantity of the one or more measurement resources. The operations of 1710 may be performed in accordance with examples as disclosed herein. In some examples, aspects of the operations of 1710 may be performed by a report manager 1130 as described with reference to FIG. 11.

At 1715, the method may include transmitting the control signaling requesting the UE to switch one or more reporting occasions from being associated with one of the channel measurement or the channel characteristic prediction to being associated with the other one of the channel measurement or the channel characteristic prediction. The operations of 1715 may be performed in accordance with examples as disclosed herein. In some examples, aspects of the operations of 1715 may be performed by a switching manager 1135 as described with reference to FIG. 11.

The following provides an overview of aspects of the present disclosure:

Aspect 1: A method for wireless communication at a UE, comprising: receiving control signaling identifying a CSI reporting setting indicating a plurality of reporting occasions, a quantity of one or more measurement resources to report for a respective reporting occasion of the plurality of reporting occasions, and that a respective reporting occasion of the plurality of reporting occasions is associated with one of channel measurement or channel characteristic prediction; generating, based at least in part on the control signaling and for a first reporting occasion of the plurality of reporting occasions, a channel measurement for the quantity of the one or more measurement resources or a channel characteristic prediction for the quantity of the one or more measurement resources; and transmitting, during the first reporting occasion, a measurement report indicating one of the channel measurement for the quantity of the one or more measurement resources or the channel characteristic prediction for the quantity of the one or more measurement resources.

Aspect 2: The method of aspect 1, wherein one bit of the CSI reporting setting indicates that the measurement report includes one of the channel measurement or the channel characteristic prediction for the respective reporting occasion.

Aspect 3: The method of any of aspects 1 through 2, further comprising: switching the respective reporting occasion from being associated with one of the channel measurement or the channel characteristic prediction to being associated with the other one of the channel measurement or the channel characteristic prediction based at least in part on a confidence level associated with the channel characteristic prediction failing to satisfy a confidence threshold.

Aspect 4: The method of any of aspects 1 through 3, further comprising: receiving the control signaling requesting the UE to switch one or more reporting occasions from being associated with one of the channel measurement or the channel characteristic prediction to being associated with the other one of the channel measurement or the channel characteristic prediction.

Aspect 5: The method of aspect 4, wherein receiving the control signaling comprises: receiving a MAC-CE or DCI requesting the UE to switch a next reporting occasion of the plurality of reporting occasions from being associated with one of the channel measurement or the channel characteristic prediction to being associated with the other one of the channel measurement or the channel characteristic prediction.

Aspect 6: The method of any of aspects 4 through 5, wherein receiving the control signaling comprises: receiving a MAC-CE or DCI indicating a change in a quantity of reporting occasions of the plurality of reporting occasions associated with the channel measurement and a change in a quantity of reporting occasions of the plurality of reporting occasions associated with the channel characteristic prediction.

Aspect 7: The method of any of aspects 4 through 6, further comprising: transmitting a feedback message indicating reception of the control signaling requesting to switch the one or more reporting occasions, wherein the feedback message comprises an acknowledgment message or a one-bit indication.

Aspect 8: The method of any of aspects 1 through 7, wherein receiving the control signaling comprises: receiving an uplink grant triggering the UE to transmit an aperiodic CSI report based at least in part on the CSI reporting setting.

Aspect 9: The method of aspect 8, wherein a priority of the aperiodic CSI report is higher than a priority of the measurement report, and wherein the measurement report is a periodic measurement report or a semi-persistent measurement report.

Aspect 10: The method of any of aspects 8 through 9, wherein the uplink grant indicates a change in a quantity of reporting occasions of the plurality of reporting occasions associated with the channel measurement and a change in a quantity of reporting occasions of the plurality of reporting occasions associated with the channel characteristic prediction, wherein the measurement report is associated with the first reporting occasion.

Aspect 11: The method of any of aspects 1 through 10, wherein the quantity of the one or more measurement resources to report is based at least in part on a measurement of the one or more measurement resources associated with a reference resource of the first reporting occasion.

Aspect 12: The method of any of aspects 1 through 11, wherein the quantity of the one or more measurement resources to report is based at least in part on a channel characteristic prediction for the one or more measurement resources associated with a reference resource of the first reporting occasion.

Aspect 13: The method of any of aspects 1 through 12, further comprising: transmitting control signaling indicating the quantity of one or more measurement resources.

Aspect 14: The method of any of aspects 1 through 13, further comprising: transmitting capability signaling indicating a capability of the UE to report the quantity of one or more measurement resources.

Aspect 15: A method for wireless communication at network entity, comprising: transmitting, to a UE, control signaling identifying a CSI reporting setting indicating a plurality of reporting occasions, a quantity of one or more measurement resources to report for a respective reporting occasion of the plurality of reporting occasions, and that a respective reporting occasion of the plurality of reporting occasions is associated with one of channel measurement or channel characteristic prediction; and receiving, during a first reporting occasion of the plurality of reporting occasions, a measurement report indicating one of a channel measurement for the quantity of the one or more measurement resources or a channel characteristic prediction for the quantity of the one or more measurement resources.

Aspect 16: The method of aspect 15, wherein one bit of the CSI reporting setting indicates that the measurement report includes one of the channel measurement or the channel characteristic prediction for the respective reporting occasion.

Aspect 17: The method of any of aspects 15 through 16, further comprising: transmitting the control signaling requesting the UE to switch one or more reporting occasions from being associated with one of the channel measurement or the channel characteristic prediction to being associated with the other one of the channel measurement or the channel characteristic prediction.

Aspect 18: The method of aspect 17, wherein transmitting the control signaling comprises: transmitting a MAC-CE or DCI requesting the UE to switch a next reporting occasion of the plurality of reporting occasions from being associated with one of the channel measurement or the channel characteristic prediction to being associated with the other one of the channel measurement or the channel characteristic prediction.

Aspect 19: The method of any of aspects 17 through 18, wherein transmitting the control signaling comprises: transmitting a MAC-CE or DCI indicating a change in a quantity of reporting occasions of the plurality of reporting occasions associated with the channel measurement and a change in a quantity of reporting occasions of the plurality of reporting occasions associated with the channel characteristic prediction.

Aspect 20: The method of any of aspects 17 through 19, further comprising: receiving a feedback message indicating reception of the control signaling requesting to switch the one or more reporting occasions, wherein the feedback message comprises an acknowledgment message or a one-bit indication.

Aspect 21: The method of any of aspects 15 through 20, wherein transmitting the control signaling comprises: transmitting an uplink grant triggering the UE to transmit an aperiodic CSI report based at least in part on the CSI reporting setting.

Aspect 22: The method of aspect 21, wherein a priority of the aperiodic CSI report is higher than a priority of the measurement report, and wherein the measurement report is a periodic measurement report or a semi-persistent measurement report.

Aspect 23: The method of any of aspects 21 through 22, wherein the uplink grant indicates a change in a quantity of reporting occasions of the plurality of reporting occasions associated with the channel measurement and a change in a quantity of reporting occasions of the plurality of reporting occasions associated with the channel characteristic prediction, wherein the measurement report is associated with the first reporting occasion.

Aspect 24: The method of any of aspects 15 through 23, wherein the quantity of the one or more measurement resources to report is based at least in part on a measurement of the one or more measurement resources associated with a reference resource of the first reporting occasion.

Aspect 25: The method of any of aspects 15 through 24, wherein the quantity of the one or more measurement resources to report is based at least in part on a channel characteristic prediction for the one or more measurement resources associated with a reference resource of the first reporting occasion.

Aspect 26: The method of any of aspects 15 through 25, further comprising: receiving control signaling indicating the quantity of one or more measurement resources.

Aspect 27: The method of any of aspects 15 through 26, further comprising: receiving capability signaling indicating a capability of the UE to report the quantity of one or more measurement resources.

Aspect 28: An apparatus for wireless communication at a UE, comprising a processor; memory coupled with the processor; and instructions stored in the memory and executable by the processor to cause the apparatus to perform a method of any of aspects 1 through 14.

Aspect 29: An apparatus for wireless communication at a UE, comprising at least one means for performing a method of any of aspects 1 through 14.

Aspect 30: A non-transitory computer-readable medium storing code for wireless communication at a UE, the code comprising instructions executable by a processor to perform a method of any of aspects 1 through 14.

Aspect 31: An apparatus for wireless communication at network entity, comprising a processor; memory coupled with the processor; and instructions stored in the memory and executable by the processor to cause the apparatus to perform a method of any of aspects 15 through 27.

Aspect 32: An apparatus for wireless communication at network entity, comprising at least one means for performing a method of any of aspects 15 through 27.

Aspect 33: A non-transitory computer-readable medium storing code for wireless communication at network entity, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive control signaling identifying a channel state information reporting setting indicating plurality of reporting occasions, a quantity of one or more measurement resources to report for a respective reporting occasion of the plurality of reporting occasions, and that a respective reporting occasion of the plurality of reporting occasions is associated with one of channel measurement or channel characteristic prediction;
generate, based at least in part on the control signaling and for a first reporting occasion of the plurality of reporting occasions, a channel measurement for the quantity of the one or more measurement resources or a channel characteristic prediction for the quantity of the one or more measurement resources; and
transmit, during the first reporting occasion, a measurement report indicating one of the channel measurement for the quantity of the one or more measurement resources or the channel characteristic prediction for the quantity of the one or more measurement resources.

2. The apparatus of claim 1, wherein one bit of the channel state information reporting setting indicates that the measurement report includes one of the channel measurement or the channel characteristic prediction for the respective reporting occasion.

3. The apparatus of claim 1, wherein the instructions are further executable by the processor to cause the apparatus to:
switch the respective reporting occasion from being associated with one of the channel measurement or the channel characteristic prediction to being associated with the other one of the channel measurement or the channel characteristic prediction based at least in part on a confidence level associated with the channel characteristic prediction failing to satisfy a confidence threshold.

4. The apparatus of claim 1, wherein the instructions are further executable by the processor to cause the apparatus to:
receive the control signaling requesting the UE to switch one or more reporting occasions from being associated with one of the channel measurement or the channel characteristic prediction to being associated with the other one of the channel measurement or the channel characteristic prediction.

5. The apparatus of claim 4, wherein the instructions to receive the control signaling are executable by the processor to cause the apparatus to:
receive a medium access control control element or downlink control information requesting the UE to switch a next reporting occasion of the plurality of reporting occasions from being associated with one of the channel measurement or the channel characteristic prediction to being associated with the other one of the channel measurement or the channel characteristic prediction.

6. The apparatus of claim 4, wherein the instructions to receive the control signaling are executable by the processor to cause the apparatus to:
receive a medium access control control element or downlink control information indicating a change in a quantity of reporting occasions of the plurality of reporting occasions associated with the channel measurement and a change in a quantity of reporting occasions of the plurality of reporting occasions associated with the channel characteristic prediction.

7. The apparatus of claim 4, wherein the instructions are further executable by the processor to cause the apparatus to:
transmit a feedback message indicating reception of the control signaling requesting to switch the one or more reporting occasions, wherein the feedback message comprises an acknowledgment message or a one-bit indication.

8. The apparatus of claim 1, wherein the instructions to receive the control signaling are executable by the processor to cause the apparatus to:
receive an uplink grant triggering the UE to transmit an aperiodic channel state information report based at least in part on the channel state information reporting setting.

9. The apparatus of claim 8, wherein a priority of the aperiodic channel state information report is higher than a priority of the measurement report, and wherein the measurement report is a periodic measurement report or a semi-persistent measurement report.

10. The apparatus of claim 8, wherein the uplink grant indicates a change in a quantity of reporting occasions of the plurality of reporting occasions associated with the channel measurement and a change in a quantity of reporting occasions of the plurality of reporting occasions associated with the channel characteristic prediction, wherein the measurement report is associated with the first reporting occasion.

11. The apparatus of claim 1, wherein the quantity of the one or more measurement resources to report is based at least in part on a measurement of the one or more measurement resources associated with a reference resource of the first reporting occasion.

12. The apparatus of claim 1, wherein the quantity of the one or more measurement resources to report is based at least in part on a channel characteristic prediction for the one or more measurement resources associated with a reference resource of the first reporting occasion.

13. The apparatus of claim 1, wherein the instructions are further executable by the processor to cause the apparatus to:
transmit control signaling indicating the quantity of one or more measurement resources.

14. The apparatus of claim 1, wherein the instructions are further executable by the processor to cause the apparatus to:
transmit capability signaling indicating a capability of the UE to report the quantity of one or more measurement resources.

15. An apparatus for wireless communication at network entity, comprising:
a processor;
memory coupled with the processor; and
instructions stored in the memory and executable by the processor to cause the apparatus to:
transmit, to a user equipment (UE), control signaling identifying a channel state information reporting setting indicating a plurality of reporting occasions, a quantity of one or more measurement resources to report for a respective reporting occasion of the plurality of reporting occasions, and that a respective reporting occasion of the plurality of reporting occasions is associated with one of channel measurement or channel characteristic prediction; and
receive, during a first reporting occasion of the plurality of reporting occasions, a measurement report indicating one of a channel measurement for the quantity of the one or more measurement resources or a channel characteristic prediction for the quantity of the one or more measurement resources.

16. The apparatus of claim 15, wherein one bit of the channel state information reporting setting indicates that the measurement report includes one of the channel measurement or the channel characteristic prediction for the respective reporting occasion.

17. The apparatus of claim 15, wherein the instructions are further executable by the processor to cause the apparatus to:
transmit the control signaling requesting the UE to switch one or more reporting occasions from being associated with one of the channel measurement or the channel characteristic prediction to being associated with the other one of the channel measurement or the channel characteristic prediction.

18. The apparatus of claim 17, wherein the instructions to transmit the control signaling are executable by the processor to cause the apparatus to:
transmit a medium access control control element or downlink control information requesting the UE to switch a next reporting occasion of the plurality of reporting occasions from being associated with one of the channel measurement or the channel characteristic prediction to being associated with the other one of the channel measurement or the channel characteristic prediction.

19. The apparatus of claim 17, wherein the instructions to transmit the control signaling are executable by the processor to cause the apparatus to:
transmit a medium access control control element or downlink control information indicating a change in a quantity of reporting occasions of the plurality of reporting occasions associated with the channel measurement and a change in a quantity of reporting occasions of the plurality of reporting occasions associated with the channel characteristic prediction.

20-27. (canceled)

28. A method for wireless communication at a user equipment (UE), comprising:
receiving control signaling identifying a channel state information reporting setting indicating a plurality of reporting occasions, a quantity of one or more measurement resources to report for a respective reporting occasion of the plurality of reporting occasions, and that a respective reporting occasion of the plurality of reporting occasions is associated with one of channel measurement or channel characteristic prediction;
generating, based at least in part on the control signaling and for a first reporting occasion of the plurality of reporting occasions, a channel measurement for the quantity of the one or more measurement resources or a channel characteristic prediction for the quantity of the one or more measurement resources; and
transmitting, during the first reporting occasion, a measurement report indicating one of the channel measurement for the quantity of the one or more measurement resources or the channel characteristic prediction for the quantity of the one or more measurement resources.

29-30. (canceled)
